(19) United States
(12) Patent Application Publication
(10) Pub. No.: US 2010/0111105 A1
(43) Pub. Date: May 6, 2010

(54) DATA CENTER AND DATA CENTER DESIGN

(76) Inventors: Ken Hamilton, Dallas, TX (US); Steve Einhom, New York, NY (US); James Warren, New York, NY (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/261,250

(22) Filed: Oct. 30, 2008

(51) Int. Cl. H04J 3/22

(52) U.S. Cl. 370/469

(57) ABSTRACT

According to one embodiment of the present invention, there is provided a data center comprising: a plurality of data center sections, each section having a different predefined level of reliability; and a plurality of sets of applications, each set of applications being populated on one of the plurality of data center sections.

### BACKGROUND

A data center is a facility that provides computing services to an enterprise. A data center typically houses a variety of computer equipment and software applications used to provision the computing services. The computer equipment may include computers and servers, network equipment, storage equipment and telecommunication equipment. Additionally, further auxiliary equipment is provided to enable the computer equipment to operate. Such auxiliary equipment may include uninterruptible power supplies (UPS) and cooling equipment.

The Telecommunications Industry Association (TIA) TIA-942: Data Center Standards Overview and the Uptime Institute define a set of 4 data center tiers based largely on levels of redundancy. For example, tier 1 data centers offer the most basic set-up, whereas tier 4 data centers offer full redundancy with 99.995% availability. Unsurprisingly, increased redundancy equates to significantly increased capital costs and operating costs. By way of example, up to 50% of a tier 3 or 4 data center may be taken up with redundant power and cooling equipment, which can translate into as much as 50% of the overall capital cost of the data center.

Typically, when an enterprise builds a data center they typically build the highest tier data center for their budget. The enterprise then populates the data center with their IT equipment and populates the IT equipment with the enterprise's software applications.

### SUMMARY

According to one aspect of the present invention, there is provided a data center comprising a plurality of data center sections. Each data center section has a different predefined level of reliability. Also provided is a plurality of sets of applications, each set of applications being populated on one of the plurality of data center sections.

According to a second aspect of the present invention, there is provided a method of designing a data center. The method comprises obtaining details of a set of applications to be populated in the data center. For each application a priority characteristic is determined. Based on the determined priority characteristics the applications are populated of different data center sections, with each data center section having a different predefined level of reliability.

### BRIEF DESCRIPTION

Embodiments of invention will now be described, by way of non-limiting example only, with reference to the accompanying drawings, in which:

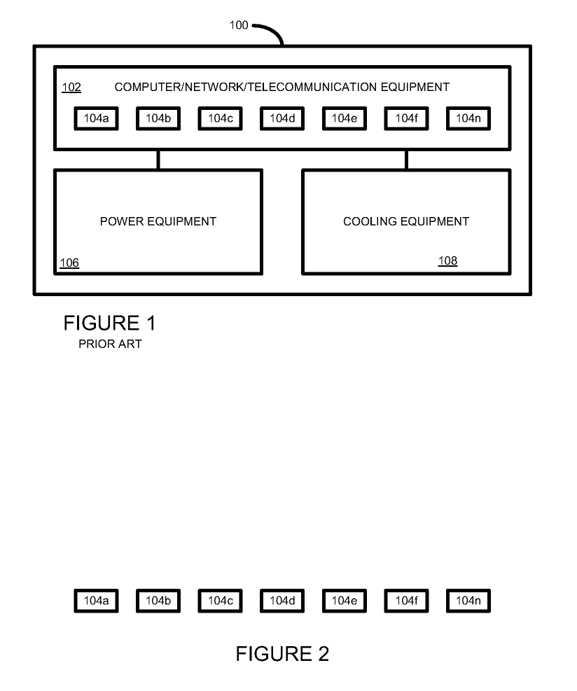

FIG. 1 is a block diagram showing a monolithic tiered data center according to the prior art;

FIG. 2 is a block diagram showing of a number of software applications;

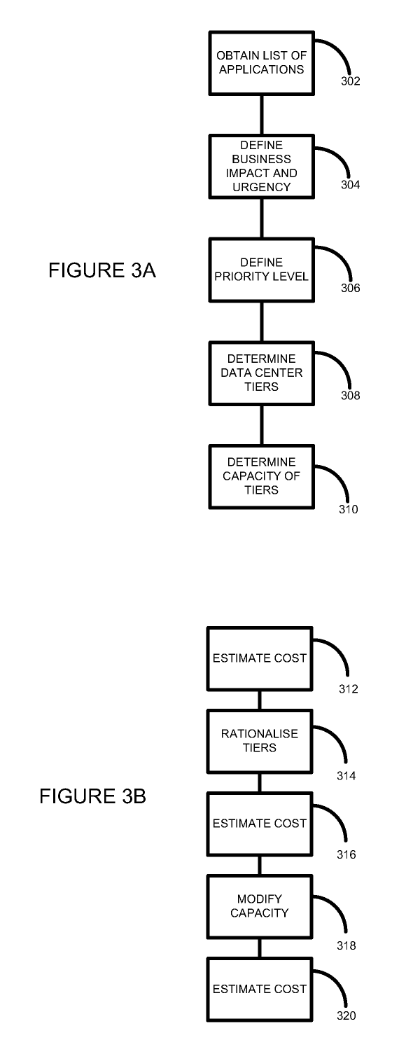

FIG. 3A is a flow diagram outlining example processing steps taken during a data center design process according to an embodiment of the present invention;

FIG. 3B is a flow diagram outlining example processing steps taken during a data center design process according to a further embodiment of the present invention;

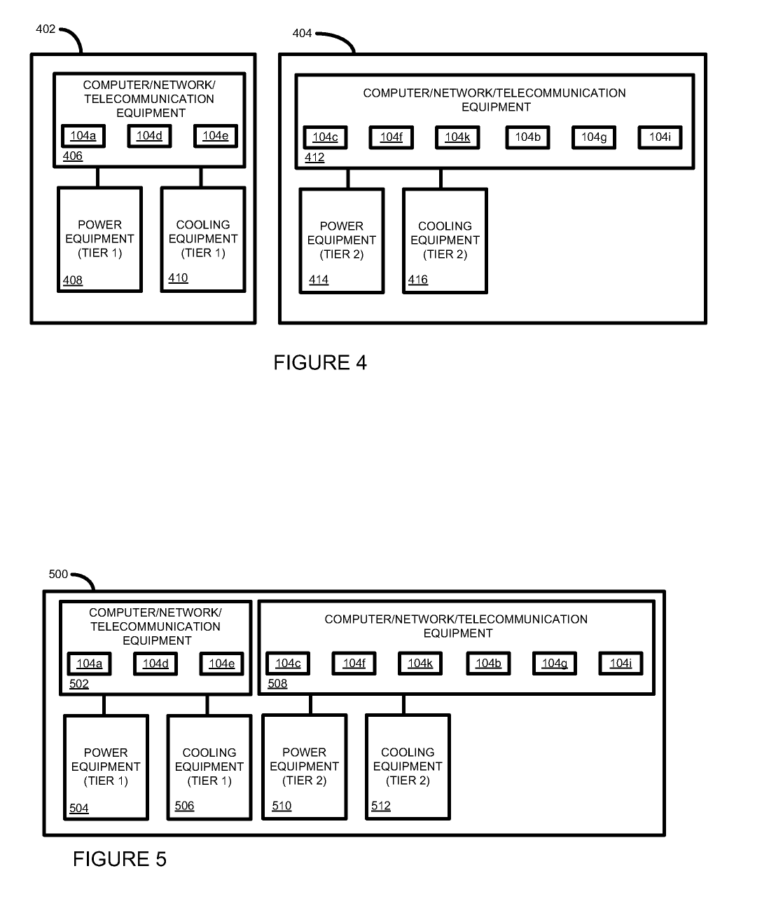

FIG. 4 is a block diagram showing a hybrid tiered data center according to one embodiment of the present invention; and

FIG. 5 is a block diagram showing a hybrid tiered data center according to further embodiment of the present invention.

### DETAILED DESCRIPTION

FIG. 1 shows a simplified block diagram of a monolithic tiered data center 100 according to the prior art. The data center 100 includes computing equipment 102, which may include computers, servers, networking, and telecommunication equipment, on which run numerous software applications 104a to 104n. The equipment 102 is powered by power equipment 106 and is cooled by cooling equipment 108. The exact nature of the power equipment 106 and cooling equipment 108 depends on the tier classification of the data center 100. For example, a tier 4 data center may have multiple power and cooling distribution paths including 2N+1 redundancy (i.e. 2 UPS each with N+1 redundancy), whereas a tier 1 data center may have only a single path for power and cooling distribution, with no redundant components.

Given the increasing operating costs of running a data center, especially with respect to power and cooling, data center operators are looking to reduce the cost of and improve the efficiency of their data centers. Currently, this is being done by applying localized solutions to power, space, and cooling. Such localized solutions include, for example, use of more energy efficient cooling systems, server consolidation, and outsourcing of workload.

The present invention, however, is based largely on the realization that significant efficiency and cost savings can be achieved if the nature of the applications intended to be run in the data center are considered during the planning, design, and configuration phases, as will be explained below in more detail.

Reference will now be made to FIG. 2, which shows a block diagram of a number of software applications 104a to 104i that are to run or are planned to be run in a data center. Additional reference is made to the flow diagrams shown in FIGS. 3A and 3B. Those skilled in the art will appreciate, however, that only a small number of software applications are discussed herein for reasons of clarity, and will further appreciate that the number of software applications in a typical data center may run into the many thousands and beyond.

At step 302 a list of software applications to be run or planned to be run in the data center is obtained. In the present example, software applications 104a to 104i are identified. These applications may be individual applications or may be a suite of one or more applications.

For each software application 104a to 104i a business impact and urgency level is assigned (step 304). In this sense, in line with standard Information Technology Infrastructure Library (ITIL) terminology, business impact refers to the impact on the enterprise business should that software application not be available, due, for example, to a hardware failure. Urgency refers to the time delay in which such an application should be made available following the application becoming unavailable. For example, in a banking environment, an application providing authorization to withdraw funds from an ATM machine may be classed as having high impact and high urgency, whereas an application providing the overnight transfer of funds from one account to another may be classed as having high impact and medium urgency.

At step 306 a priority level, based on the defined business impact and urgency is defined. Table 1 below, for example, shows an example mapping of business impact and urgency to priority.

TABLE 1
Mapping of business impact and urgency to priority

Impact

| | | High | Medium | Low |
|---|---|---|---|---|
| Urgency | High | Critical | High | Medium |
| | Medium | High | Medium | Low |
| | Low | Medium | Low | Planning |

Thus, in the present example, an application having high urgency and high business impact is defined as having a critical priority. Similarly, an application having high impact and medium urgency is defined as having a high priority.

In the present embodiment software applications 104a, 104d, and 104e are determined to be low priority, applications 104c, 104f, and 104k as medium priority, and applications 104b, 104g, and 104i as critical priority.

Once the priority of each software application has been defined, the number and type of data center sections or tiers may be determined (step 308). Currently there are 4 widely accepted industry standard data center tiers, with tier 1 data centers offering the most basic reliability levels, and tier 4 data centers offering full or near full redundancy with 99.995% availability. Those skilled in the art will appreciate that different numbers of data center sections or tiers could be used, each having a different level of reliability, redundancy, or other appropriate characteristics.

For example, if the defined priorities of the applications 104a to 104i include low, medium, and critical priorities, it may be initially determined that a data center comprising tiers 1, 2 and 4 is suitable.

In this case, for example, applications having a critical priority may be populated on computer equipment in a Tier 4 data centre, applications having a medium priority on computer equipment may be populated in a Tier 2 data centre, and applications having a low priority may be populated on computer equipment in a Tier 1 data center. In this way, each application is mapped to data center tier offering a level of reliability and redundancy corresponding to the determined priority of that application.

In step 310 the capacity of each data center tier determined in step 308 may be estimated. This estimation may be based, for example, on the performance requirements (such as required processing power, required memory, required network bandwidth, etc) of the applications intended to be populated in each data center tier, an estimated physical size of the data center tier, and/or an estimated power density of the data center tier.

According to a further embodiment, a further set of steps, shown in FIG. 3B may be additionally performed. The additional steps aim to optimize, or at least improve upon, the data center design based on financial considerations.

In step 312 an estimated capital cost of the data center is determined based, for example, on the number of determined data center tiers and their capacity.

In step 314 the data center tiers determined at step 308 are analyzed, from a financial perspective, to determine whether any consolidation of the tiers may be achieved. For example, in situations where there are large number of low and critical priority applications, and a low number of medium priority applications, it may be more cost effective to design a data center having a tier 1 section for the low priority applications and a tier 4 section for the critical and medium priority application, rather than having an additional tier 3 section just for the low number of medium priority applications. This is based on the fact that the construction of each data center tier section has a minimum fixed cost associated therewith. If appropriate, the data center design is rationalized, and a new cost estimated (step 316).

In step 318 the capacity of each proposed data center tier may be modified and its effect on the estimated cost of the proposed data center evaluated (step 320).

This process may be repeated numerous times, each time modifying different characteristics of the proposed data center. In this way, a proposed data center may be arrived at that is initially substantially optimized from a business perspective and, alternatively, additionally substantially optimized from a financial perspective. A proposed data center may include various different data center tiers of varying capacities depending on individual requirements.

The data center tiers described above may be implemented either in individual physically separate data centers, as shown in FIG. 4, or by a single hybrid tiered data center as shown in FIG. 5, or in any suitable combination or arrangement.

FIG. 4 shows a block diagram of a first data center arrangement according to an embodiment of the present invention. In FIG. 4, there are shown a number of different data centers 402 and 404. Data center 402 is a tier 1 data center, and houses low priority applications 104a, 104d, and 104f. Data center 402 has tier 1 power equipment 408 and tier 1 cooling equipment 410. Data center 404 is a tier 4 data center and houses medium priority applications 104c, 104f and 104k and critical priority applications 104b, 104g and 104i Data center 404 has tier 4 power equipment 414 and tier 4 cooling equipment 416. With appropriate network access and interconnection, the data centers 402 and 404 provide seamless enterprise computing services.

FIG. 5 shows an example hybrid tiered data center 500 designed by following the above-described methods. The hybrid tiered data center 500 provides different data center sections each providing different reliability and redundancy characteristics of different data center tiers within a single physical data center. For example, computer, network and/or telecommunication equipment 402, power equipment 404, and cooling equipment 406 are arranged to provide the reliability and redundancy characteristics of a tier 1 data center for applications 104a, 104d, and 104e. Computer, network and/or telecommunication equipment 408, power equipment 410, and cooling equipment 412 are arranged to provide the reliability and redundancy characteristics of a tier 4 data center for applications 104c, 104f, 104k, 104b 104g, and 104i.

By providing a single hybrid data center, further cost savings may be achieved by allowing sharing of common facilities and infrastructure, such as sharing of a physical enclosure or facility, sharing of security systems, access controls, and the like.

By basing the initial data center design and configuration on the business considerations, such as the priority of the applications that are to run in the data center, significant cost savings and energy efficiency can be achieved. For example, if the applications 104a to 104i were to all have been housed in a single monolithic tier 4 data center, significant capital costs and operating costs would have been wasted on providing the low and medium priority applications with a level of redundancy and reliability over and above that determined, by the business, as necessary for those applications. In existing monolithic data centers it is estimated that as many as 50% of the applications running in such data centers can be classified as non-business critical.

Although the present embodiments have been described with reference to ITIL principles, those skilled in the art will appreciate that other business service prioritization frameworks, such as ISO 20000, could also be used.

In further embodiments, not all of the method steps outline above are performed, or are performed in a sequence different from that described above.

It should also be understood that the techniques of the present invention might be implemented using a variety of technologies. For example, the methods described herein may be implemented in software executing on a computer system, or implemented in hardware utilizing either a combination of microprocessors or other specially designed application specific integrated circuits, programmable logic devices, or various combinations thereof. In particular, methods described herein may be implemented by a series of computer-executable instructions residing on a suitable computer-readable medium. Suitable computer-readable media may include volatile (e.g., RAM) and/or nonvolatile (e.g., ROM, disk) memory, carrier waves and transmission media (e.g., copper wire, coaxial cable, fiber optic media). Exemplary carrier waves may take the form of electrical, electromagnetic, or optical signals conveying digital data streams along a local network, a publicly accessible network such as the Internet or some other communication link.

1. A data center comprising:
a plurality of data center sections, each section having a different predefined level of reliability; and
a plurality of sets of applications, each set of applications being populated on one of the plurality of data center sections.

2. A data center according to claim 1, wherein each set of applications has a determined priority, and further wherein each set of applications is populated on a data section having a level of reliability corresponding to the determined level priority.

3. A data center according to claim 2, wherein the priority level of each set of applications is determined based on a determined business impact and urgency.

4. A data center according to claim 1, wherein the capacity of each of the plurality of data center sections is based on the performance requirements of the applications to be populated therein.

5. A data center according to claim 4, wherein the number of data center sections is determined in part based on determined priority of each set of applications and in part on a financial analysis.

6. The data center of claim 1, wherein the plurality of sets of applications further include applications planned to be populated on one of the plurality of data center sections.

7. The data center of claim 1, wherein each data center section is one of either an independent physical data center or a section of a data center within a single physical data center.

8. The data center of claim 7, wherein each data center section is network interconnected.

9. The data center of claim 1, wherein each data center section further comprises power and cooling equipment suitable for providing the level of reliability and redundancy required by each data center section.

10. The data center of claim 9, wherein each data center section is a section within a single physical data center, each section sharing common infrastructure elements on the same physical data center.

11. A method of designing a data center comprising:
obtaining details of a set of applications to be populated in the data center;
determining a priority characteristic for each application; and
determining, based on the obtained priority characteristics, a plurality of data center sections on which the applications are to be populated, each data center section having a different predefined level of reliability associated with the determined priority characteristic for each application.

12. A method according to claim 11, further comprising populating at least some of the plurality of applications on a data center section having a level of reliability corresponding to the determined level of priority of each application.

13. A method according to claim 11, further comprising determining the priority level of each set of applications based on a determined business impact and urgency of each application.

14. A method according to claim 11, wherein the capacity of each of the plurality of data center sections is based on the performance requirements of the applications to be populated therein.

15. A method according to claim 11, further comprising determining the number of data center sections based in part on the determined priority of each set of applications and in part on a financial analysis.

16. A method according to claim 11, further comprising refining the capacity of each of the plurality of data center sections based on a financial analysis.

17. A method according to claim 11, further comprising performing the method steps iteratively to substantially optimize the data center design.

18. A data center comprising:
a plurality of data center sections, each section having a different predefined level of reliability;
a plurality of sets of applications, each set of applications being populated on one of the plurality of data center sections; and
wherein each set of applications has a determined priority, and further wherein each set of applications is populated on a data section having a level of reliability corresponding to the determined level priority.
